(19) United States
(12) Patent Application Publication
(10) Pub. No.: US 2005/0080913 A1
(43) Pub. Date: Apr. 14, 2005

(54) Method and system for querying information from a switch by a server in a computer network

(76) Inventor: David Andrew Thomas, Atherton, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/681,243

(22) Filed: Oct. 9, 2003

(51) Int. Cl. G06F 15/16

(52) U.S. Cl. 709/230

(57) ABSTRACT

A method and system are disclosed for querying information from a switch by a first server of plural servers in a computer network. In accordance with exemplary embodiments, the first server extracts connection information from an information packet transmitted to the first server. The first server determines whether the first server is handling a connection associated with the information packet. The first server constructs a query information packet when the first server determines that the first server is not handling the connection associated with the information packet. The query information packet includes query information for a switch. The first server forwards the query information packet to the switch. The switch constructs a response information packet. The response information packet includes a secondary network address of a server of the plurality of servers that is handling the connection associated with the information packet. The switch forwards the response information packet to the first server.

### CROSS REFERENCE TO RELATED APPLICATIONS

This application is related to U.S. patent application entitled “Method and System for Managing Fragmented Information Packets in a Computer Network,” Ser. No. 10,289,308 (Attorney Docket No. 10014761), to U.S. patent application entitled “Method and System for Managing Connections in a Computer Network,” Ser. No. 10/289,288 (Attorney Docket No. 10014762), to U.S. patent application entitled “Method and System for Communicating Information Between A Switch and a Plurality of Servers in a Computer Network”, Ser. No. 10/289,282 (Attorney Docket No. 10014763), to U.S. patent application entitled “Method and System for Reestablishing Connection Information on a Switch Connected to a Plurality of Servers in a Computer Network,” Ser. No. 10/289,311 (Attorney Docket No. 10014764), to U.S. patent application entitled “Method and System for Managing Communication in a Computer Network Using Aliases of Computer Network Addresses,” Ser. No. 10/289,379 (Attorney Docket No. 10014765), and to U.S. patent application entitled “Method and System for Predicting Connections in a Computer Network,” Ser. No. 10/289,259 (Attorney Docket No. 10015521), each of which was filed on Nov. 7, 2002 and each of which is hereby incorporated herein by reference in its entirety.

### BACKGROUND

To access information on the Internet and, more particularly, the World Wide Web (WWW), users access websites that offer information and/or services. The information and/or services offered by a website are stored in and provided by computer network servers that are generally located remotely from the user. As the number of Internet users grow, computer network servers can experience an increase in the number of connections from clients to access the information and/or services available on these websites. To handle the increased connection load, the computer network servers can be scaled to meet the increased demand. For example, computer network servers can be replicated and the server replicas can be clustered to meet the increased demand. Thus, as the client connection load increases, more servers can be replicated and clustered. Because of their scalability and flexibility, computer network server clusters have become a popular method of meeting increasing communications traffic demands.

Computer network servers based on clusters of workstations or personal computers (PCs) generally include a specialized “front-end” device that is responsible for distributing incoming requests from clients to one of a number of “back-end” nodes, where the “back-end” nodes are responsible for processing the incoming requests from the clients. The front-end is responsible for handing off new connections and passing incoming data from the client to the back-end nodes. In cluster server architectures, the front-end can use weighted round-robin request distribution to direct incoming requests to the back-end nodes. With weighted round-robin distribution, incoming requests are distributed in round-robin fashion and are weighted by some measure of the load on the different back-ends.

To distribute the communications traffic among the back-end nodes, the front-end acts as a load balancer that attempts to evenly distribute the communications traffic load from the clients among the available back-end nodes. A load balancer can be, for example, a switch that connects the servers to the clients for whom the information and/or services are to be provided. To meet increasing connection loads, the load balancers can be upgraded with faster computer processors and more internal computer memory. To further increase performance and improve connection distribution among the back-end nodes, the front-end can use, for example, the content requested, in addition to information about the load on the back-end nodes, to choose which back-end server will handle a particular request.

Content-based request distribution is discussed in, for example, “Locality-Aware Request Distribution in Cluster-Based Network Servers,” by Vivek S. Pai, et al. (Proceedings of the ACM Eighth International Conference on Architectural Support for Programming Languages and Operating Systems (ASPLOS-VIII), October 1998), the disclosure of which is incorporated herein by reference in its entirety. However, current load balancers (e.g., front-end switches) do not use the resources offered by the back-end server nodes, which are typically faster and more powerful than the load balancers, to assist the load balancer in determining the distribution of the connections among the back-end nodes. Rather, current load balancers determine request distribution autonomously from the back-end nodes.

One example of a conventional load balancer that can act as a front-end for a computer network cluster is a Layer Four (L4) switch. A L4 switch takes into account Transport Layer information (i.e., Layer Four of the International Organization for Standardization (ISO) Networking model, or ISO model). A discussion of computer network protocols and layers of the ISO model is discussed, for example, in “Interconnections, Second Edition,” by Radia Perlman (Addison-Wesley, 2000), the disclosure of which is incorporated herein by reference in its entirety. L4 switches manipulate both the network and transport protocol headers of the communications traffic passing through them to forward the communications traffic to the back-end nodes. A L4 switch can operate with, for example, the Internet Protocol (IP) for the network layer and the Transport Control Protocol (TCP) for the transport layer.

To efficiently distribute the connection load between the back-end servers, the switch gathers load information autonomously from the servers. Communicating information from the back-end servers to the switches to assist the switch in load balancing can introduce a significant overhead in information transmission between the back-end servers and the switch. For example, a load balancer for WWW traffic can experience a workload of short-lived connections, with each connection having a small number of packets. Injection of additional “control packets” to communicate load information from the back-end servers to the switch can contribute a significant overhead to connections with short exchanges.

### SUMMARY

A method and system are disclosed for querying information from a switch by a first server of plural servers in a computer network, comprising: extracting, by the first server, connection information from an information packet transmitted to the first server; determining, by the first server, whether the first server is handling a connection associated with the information packet; constructing, by the first server, a query information packet when the first server determines that the first server is not handling the connection associated with the information packet, wherein the query information packet includes query information for a switch; forwarding, by the first server, the query information packet to the switch; constructing, by the switch, a response information packet, wherein the response information packet includes a secondary network address of a server that is handling the connection associated with the information packet; and forwarding, by the switch, the response information packet to the first server.

Exemplary embodiments of a system for querying a switch by a server in a computer network, comprise: a first server of a plurality of servers for extracting connection information from an information packet transmitted to the first server, for determining whether the first server is handling a connection associated with the information packet, for constructing a query information packet when the first server determines that the first server is not handling the connection associated with the information packet, wherein the query information packet includes query information, and for forwarding the query information packet. A switch is connected to the plurality of servers, for receiving the query information packet forwarded by the first server, for constructing a response information packet, wherein the response information packet includes a secondary network address of a server of the plurality of servers that is handling the connection associated with the information packet, and for forwarding the response information packet to the first server.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for querying a switch of a computer network in accordance with an exemplary embodiment.

FIG. 2 is a flowchart illustrating a method for querying a switch of a computer network in accordance with an exemplary embodiment.

### DETAILED DESCRIPTION OF THE PREFERRED EMBODIMENTS

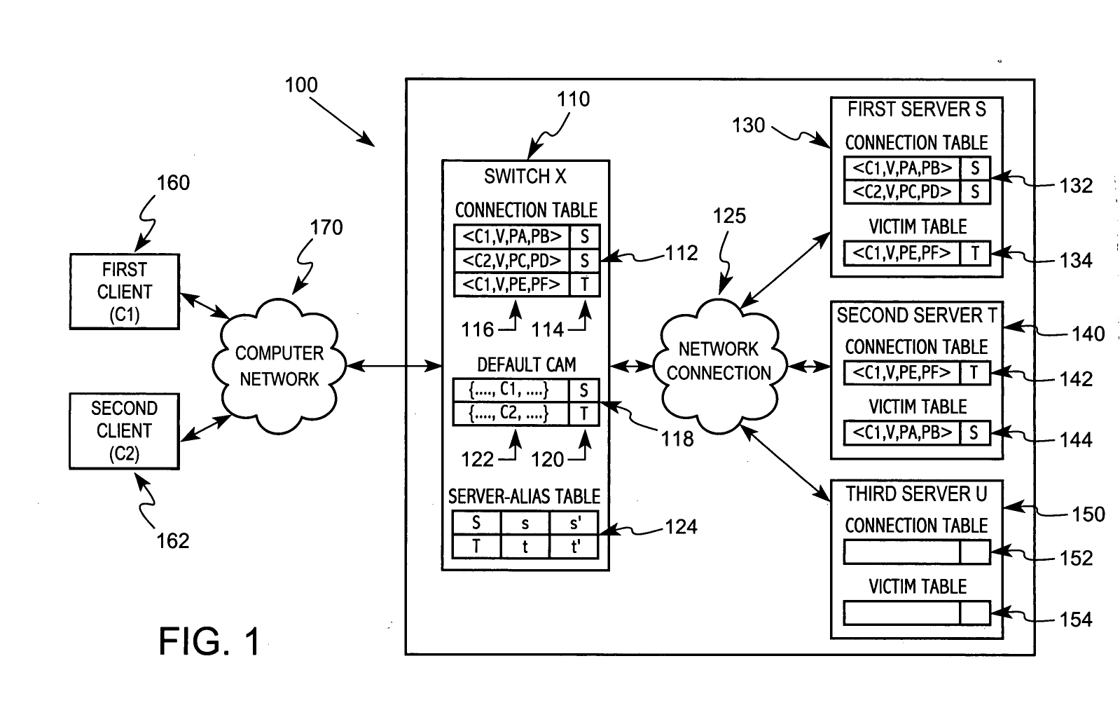

FIG. 1 is a block diagram illustrating a system 100 for querying a switch of a computer network in accordance with an exemplary embodiment. System 100 includes a first server 130 of a plurality of servers for extracting connection information from an information packet transmitted to the first server 130, and for determining whether the first server 130 is handling a connection associated with the information pocket. An exemplary information packet can include a header portion and a data portion, or payload.

An exemplary IP header is as follows:

| | | | |
|---|---|---|---|
| 4-bit version | 4-bit header length | 8-bit Type | 16-bit total length |
| | | of Service | |

| | | | | |
|---|---|---|---|---|
| 16-bit identification | 0 | D | M | 13-bit |
| | | F | F | fragment |
| | | | | offset |

| | | |
|---|---|---|
| 8-bit TTL | 8-bit protocol | 16-bit header checkum |

32-bit source IP address
32-bit destination EP address

The first server 130 can construct a query information packet when the first server 130 determines that the first server 130 is not handling the connection associated with the information packet, and can forward the query information packet. The query information packet can include query information.

System 100 includes a switch 100, connected to a plurality of servers, for receiving the query, for constructing a response information packet, and for forwarding the response information packet to the first server 130. According to exemplary embodiments, the response information packet can include a secondary network address of a second server (for example, server 140) that is handling the connection associated with the information packet.

Exemplary embodiments can use existing information packet headers to supply the query information from any of the plurality of servers to the switch (for example, portions of the headers that are unused in conveying information from the server to a client through the switch). Exemplary embodiments can thus exploit the use of traffic between the servers and clients to piggyback control information, thereby reducing or eliminating traffic associated with the supply of control information to the switch. Alternately, a dedicated query information packet can be sent from a server to the switch.

According to exemplary embodiments, the FIG. 1 computer network 170 can be any type of computer network in which information in the form of packets can be transmitted, received, or otherwise communicated within and throughout the computer network. For example, computer network 170 can be a local area network (LAN), wide area network (WAN), any type of intranet or internet, or any other type of computer network or computer system capable of transporting packets of information.

As used herein, an “information packet” can be any format of aggregated bits that forms a protocol data unit (PDU) that is capable of carrying any type of information over a packet-switching network. The information packet can carry, for example, data, commands, or any other type of information. According to exemplary embodiments, an information packet can be a transmission control protocol (TCP) PDU, a user datagram protocol (UDP) PDU, or any other form of packet that is capable of carrying any type of information over a packet-switching network.

Switch 110 can receive an information packet through computer network 170 from a client, such as, for example, first client 160, second client 162, or any number of clients. As used herein, a “client” can be any type of computer system, such as, for example, a personal computer (PC), a workstation, a minicomputer, a supercomputer, or any other form of computer system capable of transmitting and receiving information packets over a computer network. According to exemplary embodiments, the client can request information or services from one or more of the plurality of servers over the computer network. Switch 110 can be connected to the clients remotely. If connected remotely, computer network 170 can be any form of WAN or for example, the Internet. However, switch 110 can be connected to the clients locally using, for example, a LAN or a direct connection to switch 110.

System 100 includes a plurality of servers, such as first server 130, second server 140, third server 150, and the like. According to exemplary embodiments, a primary network address and at least a secondary network address are assigned to each of the plurality of servers. The secondary network address of each server is an alias for the primary network address of the server. According to exemplary embodiments, each server can be any type of computer system, such as a personal computer (PC), a workstation, a minicomputer, a supercomputer, or any other form of computer system capable of transmitting and receiving information packets over a computer network. According to exemplary embodiments, each server of the plurality of servers can provide information or services to one or more clients over a computer network in response to requests from the one or more clients for such information or services. System 100 can include any number of servers.

The plurality of servers can be connected to switch 110 through a network 125. Network 125 can be any type of computer network where the Layer 2 header is preserved (for example, a LAN, WAN, or any form of intranet where the Layer 2 header is preserved). The plurality of servers can be connected to switch 100 through network 125 using any form of computer network connection, such as, for example, an Ethernet connection. According to an alternate embodiment, the plurality of servers can be connected directly to switch 110 using any form of connection (e.g., electrical, optical, wired, wireless or the like) capable of transmitting and receiving information between the plurality of servers and switch 110. In such an alternate embodiment, the network connection of network 125 is a direct connection. According to exemplary embodiments, although the plurality of servers can communicate with the clients through switch 110, the plurality of servers can send additional information packets to clients through computer network 170 using alternate mechanisms. For example, the plurality of servers can also include additional network interfaces that connect each of the servers to computer network 170 so that computer network communication can take place without the use of switch 110.

According to exemplary embodiments, switch 110 can be a Layer 4 (L4) switch. A L4 switch takes into account Transport Layer Information (i.e., Layer 4 of the ISO model). For example, the L4 switch can examine port numbers of the TCP protocol, although switch 110 can use other transport and network protocols, such as, for example, UDP. A switch can operate at the Data Link Layer (i.e., Layer 2 of the ISO model). An exemplary Data Link Layer is Ethernet. An Ethernet switch can forward packets without modification.

In contrast to a switch, a router can operate at the Network Link Layer (i.e., Layer 3 of the ISO model). An example of a Network Link Protocol is the Internet Protocol (IP). A network router can interconnect different link layers and generate a new link layer header for each packet passing through the network router. A network router can also manipulate the IP header of packets passing through the network router.

Switch 110 can be a hybrid of the Ethernet switch and the network router. For example, switch 110 can rewrite or otherwise manipulate the link layer header of information packets, but does not modify information packets in the manner performed by routers. According to exemplary embodiments, switch 110 can use the IP protocol for the network layer and the TCP protocol for the transport layer, although different protocols can be used for the various layers.

Switch 110 can store, maintain, and manage several tables that can be used to forward information packets between the clients and the plurality of servers. Each table is a collection of information that can be stored in any type of computer memory in switch 110, such as, for example, Random Access Memory (RAM), a hard disk, or any other type of electronic storage medium. For each table, a key/value pair can be used to access information—the key is used to index and locate information in the table and the value is associated with the key.

A table that can be maintained by switch 110 is a connection table 112. Connection table 112 maps connections switch 110 has been informed about to the server that is handling the connection, wherein information packets are communicated between a client and a server of the plurality of servers over the connection. Value field 114 of connection table 112 can hold the name, address or any other designation of a server. Key field 116 can be used to index or otherwise locate the value in value field 114 that corresponds to the particular key field. According to an exemplary embodiment, connection table 112 can be a hash table maintained in RAM of switch 110.

According to exemplary embodiments, another table that can be maintained by switch 110 is a default content addressable memory (CAM) 118. Default CAM 118 can provide, for example, an initial assignment of connections to servers and it can provide the mapping of non-first fragments to servers. According to exemplary embodiments, default CAM 118 can be a ternary CAM.

A role of the default CAM, according to exemplary embodiments of the present invention, is to implement a dispersal algorithm for handling the absence of connection information in the connection table. The default CAM can be accessed during an initial assignment of connections as mentioned, but can also be accessed when connection information has been lost, deleted, or rendered inaccessible from the connection table for any reason. The dispersal algorithm can be established at the switch by the system in advance, or can be established at the switch by having at least one of the plural servers notify the switch of the dispersal algorithm to be used for allocating computer network address space of the plural servers. In this latter case, a first server can run the dispersal algorithm on all of its connections, and inform all of its potential victim servers of the connections each such victim server will be handling for the first server. Each of the remaining servers can do the same.

An exemplary dispersal algorithm can be a predetermined pattern matching algorithm implemented using a ternary CAM (or other desired mechanism). In a scenario where information (e.g., first information) is directed to the switch from a client, but there is no connection information in the connection table of the switch, the default CAM can be accessed to identify an appropriate so-called victim server to which the first information packet should be forwarded. The servers handle the forwarding of the first information packet from the victim server to the appropriate destination server. A ternary CAM is suitable for use as the default CAM because it is a content addressable memory with “don't care” matching to provide wildcards on various fields of value field 120 as accessed by key field 122. Thus, the ternary CAM can provide pattern matching. If a value matches several patterns in default CAM 118, a priority encoder can be used to determine the result. Priority encoders are described, for example, in U.S. Pat. No. 5,964,857, the entire disclosure of which is hereby incorporated herein.

For example, each information packet can include a connection tuple having a designated number of bits used to represent at least five fields for specifying a source Internet Protocol (IP) address, a destination IP address, a source port, a destination port and a protocol. These bits can be considered to designate an address space that can be allocated among the plural servers. In the absence of connection information in the connection table, the default CAM can be accessed to determine a match on a selected number of these bits (e.g., a match on the four least significant bits of the source IP address whereby a first portion of the address space from “0000” to “0011” can be allocated to a first of four servers). The information packet is thus forwarded to the server preassigned to handle any information packets within the first portion of the address space. The servers can have a preestablished mechanism (e.g., victim tables) for forwarding information packets from a particular victim server to an appropriate destination server.

As an alternate to using predetermined pattern matching, the dispersal algorithm can, for example, be a hash function. That is, any or all of the bits received in an information packet can be used to calculate an entry to a hash table, which in turn, designates an appropriate victim server.

In addition to the connection table and the default CAM, another table that can be maintained by switch 110 is a server-alias table 124. According to exemplary embodiments, server-alias table 124 can perform several functions. For example, server-alias table 124 can contain a list of the plurality of servers. The name, address or other designation of each of the servers can be the value accessed by a key to index or otherwise locate information in the server-alias table (e.g., the Ethernet address corresponding to the IP address of a server). Server-alias table 124 can also contain a list of alias addresses for servers that are used by the switch.

According to exemplary embodiments, each of the plurality of servers can also store, maintain, and manage several tables for connection management. Each table is a collection of information that can be stored in any type of computer memory in each of the plurality of servers, such as, for example, Random Access Memory (RAM), a hard disk, or any other type of electronic storage medium. For each table, a key/value pair can be used to access information—the key is used to index and locate information in the table and the value is associated with the key.

Each of the plurality of servers can have a connection table, such as, for example, connection table 132 of first server 130. The server connection table can contain a list of the connections for which the server is the terminating server. In other words, the server connection table lists those connections that the server is handling. Each of the plurality of servers can also include a victim table, such as, for example, victim table 134 of first server 130. The victim table can contain the connection and fragment information that the server handles on behalf of another server. In other words, the victim table lists certain non-terminating connections on which the server will receive packets. For each of the information packets received on the non-terminating connection, the victim table lists the terminating server to which the non-terminating server can relay the information packets. As already mentioned, the victim tables can be populated as a function of the selected dispersed algorithm.

For purposes of illustration, as shown in FIG. 1, IP addresses are denoted by uppercase letters (e.g., C1, C2, S, T, U). Ethernet addresses (i.e., Medium Access Control (MAC) addresses) are denoted by lowercase letters (e.g., c1, c2, s, t, u). As discussed below, switch 110 can masquerade as a server to pass server address information from one server to another. When switch 110 masquerades as a server, it can use alias addresses denoted by lowercase letters with apostrophes (e.g., s′, where s' is an alias for s).

Switch 110 can connect a plurality of servers to clients over computer network 170. Thus, the switch can act as a “front-end” to the plurality of servers, while the plurality of servers can act as the “back-end.” IP aliasing can be used when communicating information packets between the plurality of servers and the clients through switch 110. With IP aliasing, switch 110 and the plurality of servers are addressed to clients using a single, collective IP address (e.g., an address “V”). In other words, switch 110 and the plurality of servers appear as a single computer system with a single IP address (e.g., address “V”), such that “knowledge” of the separate components of system 100 is hidden from the clients.

Thus, when a client addresses switch 100 and plurality of servers, the client simply sends an information packet to a single IP address (e.g., address “V”). Switch 110 will then direct the packet to the server handling the connection to the client. When sending information packets to clients using IP aliasing, each of the plurality of servers can write the IP source address as the single, collective IP address (e.g., address “V”), and not the server's unique IP address. However, according to exemplary embodiments, at the Ethernet layer, each of the plurality of servers can use their individual Ethernet addresses (i.e., MAC address) as their source Ethernet address.

According to exemplary embodiments, amongst the Layer 2 (L2) (i.e., Ethernet) packet layer, Layer 3 (L3) (i.e., IP) packet layer, and the L4 (e.g., TCP) packet layer, there are six fields which can used to represent packets in system 100: an Ethernet destination address (from the L2 packet layer); an Ethernet source address (from the L2 packet layer); a source IP address (from the L3 packet layer); a destination IP address (from the L3 packet layer); a source port (from the L4 packet layer); and a destination port (from the L4 packet layer). Those skilled in the art will appreciate that an additional protocol field can be included (e.g., to identify TCP), and need not be discussed further. For purposes of illustration and not limitation, a packet from first client 160 (i.e., “C1”) to system 100 (i.e., “V”) can have the following fields, where “s” represents the Ethernet address of first server 130, “x” represents the Ethernet address of switch 110, and “PA” and “PB” are the source and destination TCP ports, respectively[x, c1, C1, V, PA, PB]. For example, if first server 130 is handling the connection, the switch 110 can rewrite the packet as: [s, x, C1, V, PA, PB]. When the server sends a reply, the server uses the IP alias “V” instead of its own IP address. Consequently, the reply packet is: [x, s, V, C1, PB, PA].

As noted, the reply packet swaps the source and destination IP addresses. From this swapping, a canonical addressing format can be used to represent packets as follows: <client IP address, server IP address, client port, server port>. The canonical addressing format can be used to represent packets and connections in system 100 of FIG. 1. According to exemplary embodiments, if the packet came from a client, then the fields are in canonical form. If the packet came from a server, then the fields can be swapped to generate the canonical form.

Switch 110 can use server-alias table 124 to determine if the packet was sent by a server, and, therefore, the fields should be rearranged. If “V” is the source IP address, then the fields should be swapped. By using a canonical form in accordance with exemplary embodiments, connection table 112 can use a single entry to track a connection for each packet direction. Alternatively, two indices can be used—one for each packet direction.

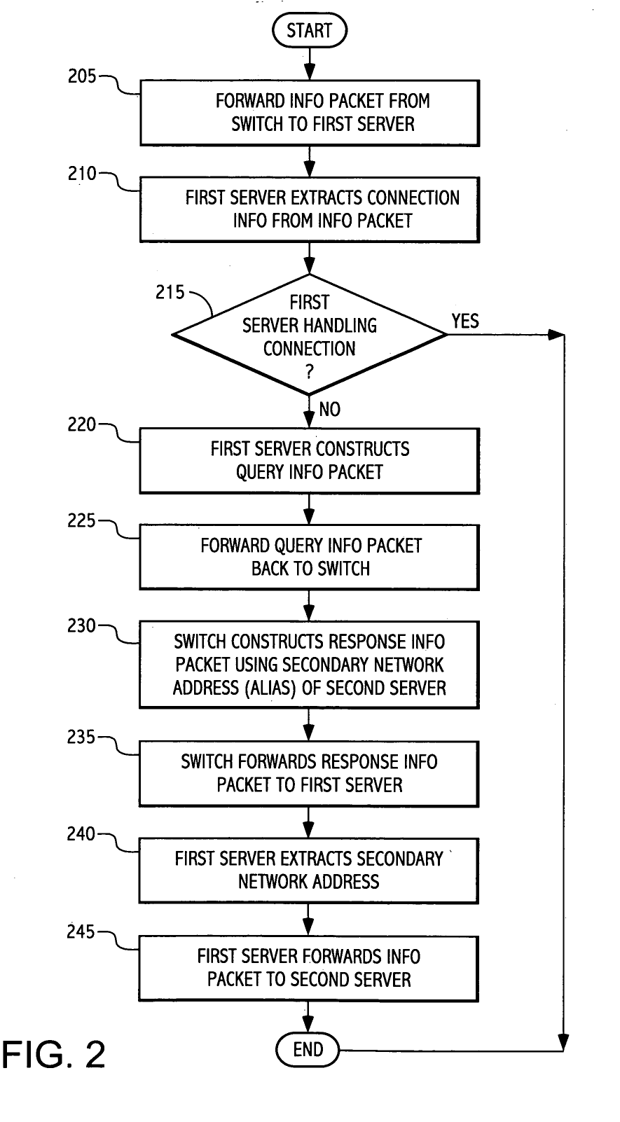

Operation of the FIG. 1 system will be described with respect to the FIG. 2 process, illustrated as a flowchart. At block 205, the FIG. 1 switch forwards an information packet (for example, an information packet received from a client) to a first server, such as server 130. In block 210, the first server 130 extracts connection information from the information packet transmitted by the switch. By examining its connection table 132, the first server 130 determines whether it is handling a connection associated with the information packet in block 215. If so, the server 130 proceeds with handling of the information packet, and there is no need for a query information packet to be sent to the switch 110. However, if server 130 is not handling any connection included in the information packet, the FIG. 2 process flows to block 220.

In block 220, the first server constructs a query information packet when the first server determines that it is not handling the connection associated with the information packet. The query information packet includes query information for a switch, such as switch 110.

To modify an information packet for communicating a query information packet from a server to the switch 110 in accordance with an exemplary embodiment, a first server in FIG. 1, such as server 130, modifies a header of the information packet. That is, any portion of the information packet which the switch will examine can be modified to construct a query information packet which contains the query information.

Alternately, the query information can be included in the data portion, or payload, of a query information packet that has been constructed as a dedicated control information packet. The first server can transmit the control information packet to the switch. The switch then extracts the query information from the control information packet.

The query information packet can be forwarded (transmitted) to the switch 110 in block 225 of FIG. 2. The switch 110 receives the query information packet from the first server, and extracts the query information.

The switch can respond to the query information by treating the query information packet from the first server as a request for an address of a second server that is handling the connection associated with the information packet. The switch can search its connection table for a second server handling the connection (for example, server 140), and then identify a secondary network address of the second server using the server-alias table 124. In block 230, the switch can construct a response information packet which includes the secondary network address of the server (e.g., the second server 140) that is handling the connection associated with the information packet. The response information packet is then forwarded to the first server so that the first server can extract the secondary network address of the second server in block 240, and then transmit the original information packet to the second server in block 245.

In another example, the query information received from the first server can be forwarded by the switch 110 to the second server 140, with the alias of the first server in, for example, the source address. This conveys to the second server that the first server has a packet for it, and the second server can then contact the first server to retrieve the packet.

In the foregoing examples, the query information sent by the first server to the switch can include a first command which serves as a query location command. The burden of determining an appropriate server is thus shared by the switch and the plural servers on the back-end. Information packet formats that contain a number of optional fields can be difficult to process in hardware on the switch. Accordingly, switch 110 can be configured to deal with the frequently used optional fields, and defer parsing of complex options to a back-end server which, because it may not be the correct server for handling the connection, constitutes a “victim” server.

When a first server, such as server 130, receives a complex information packet such as an information packet having identifiable characteristics recognizable by the switch (using, for example, a look-up table), the first server can perform the operation of parsing the packet to obtain the connection tuple. As described herein, if the first server is not the correct server, it queries the switch with a query information packet to have the switch identify the correct server. The switch can construct query response information that is forwarded by the switch to the first server in block 235.

In an exemplary embodiment, the query response information packet can provide the secondary network address (that is, server alias address) of the second server in, for example, the Ethernet (MAC) source address field of a header of the response information packet. On receiving this query response information packet, the first server can send the original packet to the correct server. Because the query response information packet is not destined for a client, the modified information in the packet can be sent to the first server. The first server can detect a query response packet where, for example, the source address is the first server's so-called victim address.

To implement a query location command, and/or to implement the conveyance of any desired information, an original state of an information packet can be modified to include a bit (or plural bits) for signaling a query location operation. The remaining information used to convey information for use by the switch can, for example, come from the preexisting packet header (e.g., the connection tuple is in the packet header).

To modify (e.g., piggyback) an original state of a standard information packet with query information, unused bits of the IP header can be exploited in an exemplary embodiment. Information used to modify the information packet can then be removed at the switch (e.g., by zero'ing it out).

A coding violation can be introduced in the IP header to identify information packets which carry query location information for use by the switch. There are several ways in which this coding violation can be accomplished. For example, an IP header can contain fields to specify: packet version (e.g., 4-bit field), header length (e.g., 4-bit field), type of service (TOS) (e.g., 8-bit field); total length of the information packet (e.g., 16-bit field), identification field (e.g., 16 bit field), fragment offset (e.g., 16-bit field), TTL (e.g., 8-bit field), protocol (e.g., 8-bit field), header checksum (e.g., 16-bit field), source IP address (e.g., 32-bit field) and destination IP address (e.g., 32-bit field).

The Type-Of-Service (TOS) field has been specified as a three bit precedence field, 4 TOS bits and an unused bit set to 0. The bit next to DF, has also been specified as 0. In an exemplary embodiment, these two bits can be specified as “must be 0”; accordingly, if either of these specified bits is altered by a server (e.g., changed to “1”), a coding violation is indicated, that signifies the information packet header includes information in a designated area for use by the switch.

Of course numerous possibilities exist for establishing header specifications that, if deviated from, would signal a coding violation to the switch. For example, the total length field refers to the length of the IP packets. On an exemplary Ethernet link layer, this can not be greater than 1500 bytes, so the top 5 bits of this field would be set to 0 in a correctly coded packet. Accordingly, some of these bits can be used to convey a code violation, and/or to provide the query information to the switch. These five bits can, for example, be used to encode a control command.

In an exemplary embodiment, one of these five bits can be used to signify a modified header (that is, signal to the switch that the information packet contains information for use by the switch), and a second of the five bits can be used to designate a query location. Alternately, any of the remaining three bits can be used to encode a command field with up to eight different commands, one of which can be the query location command.

In one example, the first server can send a query information packet as follows:
Header: server ID, switch ID, source port ID, destination port ID
Payload: Query: Request Correct Server For Connection Table Entry <C, S, PA, PB> (where C is a client, S, is a server, and PA, PB are source and destination ports).

According to exemplary embodiments of the present invention, the information of the dedicated control message can be woven into an information packet to decrease network traffic. As already mentioned, this can be achieved by exploiting unused bits and introducing a coding violation of a packet intended for a client.

For example, the query information can be fused into a single information packet as follows:
Header: C, S[query information] PA, PB
Payload: message to client.

At the switch, the query information is removed along with any bits modified to encode the commands (e.g., fragment offset bits). The switch generates a response information packet upon receipt of the query information. For the example above, the switch can construct a response information packet as follows:
Header: switch IP, server ID, source port ID, destination port ID
Payload: server ID of correct server, or alias ID thereof.
   Alternately, the switch can place the secondary network address of the correct server (that is, the address of the second server) in the Ethernet (MAC) source address field of the header in the response information packet. The query information can be retained in the query response information packet, or can be removed by the switch.

In block 240 of FIG. 2, the first server extracts the secondary network address from the response information packet. The original information packet is then forwarded by the first server to the secondary network address of the correct server for handling the connection.

A computer program can be used to implement the process illustrated in FIG. 2 for communicating query information between a switch and a plurality of servers in a computer network. As such, the program can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method for querying information from a switch by a first server of plural servers in a computer network, comprising:
extracting, by the first server, connection information from an information packet transmitted to the first server;
determining, by the first server, whether the first server is handling a connection associated with the information packet;
constructing, by the first server, a query information packet when the first server determines that the first server is not handling the connection associated with the information packet, wherein the query information packet includes query information for a switch;
forwarding, by the first server, the query information packet to the switch;
constructing, by the switch, a response information packet, wherein the response information packet includes a secondary network address of a server that is handling the connection associated with the information packet; and
forwarding, by the switch, the response information packet to the first server.

2. The method of claim 1, comprising the step of:
forwarding the information packet to the first server from the switch.

3. The method of claim 1, wherein the first server modifies a header of the query information packet to include the query information for the switch.

4. The method of claim 1, wherein the query information is included in a payload of the query information packet.

5. The method of claim 1, wherein the query information requests from the switch an address of a server of the plurality of servers that is handling the connection associated with the information packet.

6. The method of claim 1, wherein the switch searches connection information to determine the secondary network address of the server that is handling the connection associated with the information packet.

7. The method of claim 1, wherein the response information packet includes the secondary network address in an ethernet source address field of a header of the response information packet.

8. The method of claim 7, wherein the response information packet includes the query information from the query information packet.

9. The method of claim 1, comprising the step of:
extracting, by the first server, the secondary network address from the response information packet; and
forwarding the information packet to the secondary network address of the server of the plurality of servers that is handling the connection associated with the information packet.

10. The method of claim 1, wherein the information packet is a transmission control protocol (TCP) protocol data unit (PDU).

11. The method of claim 1, wherein the information packet is a user datagram protocol (UDP) protocol data unit (PDU).

12. A system for querying a switch by a server in a computer network, comprising:
a first server of a plurality of servers for extracting connection information from an information packet transmitted to the first server, for determining whether the first server is handling a connection associated with the information packet, for constructing a query information packet when the first server determines that the first server is not handling the connection associated with the information packet, wherein the query information packet includes query information, and for forwarding the query information packet; and
a switch, connected to the plurality of servers, for receiving the query information packet forward by the first server, for constructing a response information packet, wherein the response information packet includes a secondary network address of a server of the plurality of servers that is handling the connection associated with the information packet, and for forwarding the response information packet to the first server.

13. The system of claim 12, wherein the switch is configured to forward the information packet to the first server.

14. The system of claim 12, wherein the first server is configured to modify a header of the query information packet to include the query information for the switch.

15. The system of claim 12, wherein the query information is included in a payload of the query information packet.

16. The system of claim 12, wherein the query information requests from the switch an address of a server of the plurality of servers that is handling the connection associated with the information packet.

17. The system of claim 12, wherein the switch is configured to search connection information to determine the secondary network address of the server that is handling the connection associated with the information packet.

18. The system of claim 12, wherein the response information packet includes the secondary network address in an ethernet source address field of a header of the response information packet.

19. The system of claim 18, wherein the response information packet includes the query information from the query information packet.

20. The system of claim 12, wherein the first server is configured to extract the secondary network address from the response information packet, and to forward the information packet to the secondary network address of the server of the plurality of servers that is handling the connection associated with the information packet.

21. The system of claim 12, wherein the information packet is a transmission control protocol (TCP) protocol data unit (PDU).

22. The system of claim 12, wherein the information packet is a user datagram protocol (UDP) protocol data unit (PDU).
